(19) United States
(12) Patent Application Publication
(10) Pub. No.: US 2014/0202053 A1
(43) Pub. Date: Jul. 24, 2014

(54) SIGNBOARD STRUCTURE

(71) Applicant: Cheng-Chen CHEN, New Taipei City (TW)

(72) Inventor: Cheng-Chen CHEN, New Taipei City (TW)

(21) Appl. No.: 13/746,962

(22) Filed: Jan. 22, 2013

(51) Int. Cl. G09F 13/00

(52) U.S. Cl. CPC G09F 13/00
USPC 40/541

(57) ABSTRACT

A signboard structure includes a base, at least a pair of first electrodes and a pair of second electrodes. The base is formed with plural insertion holes, and includes a tenon and an engaging slot having a contour mated with the tenon. The first electrodes are disposed in the base corresponding to the locations of the insertion holes, and each of the first electrodes is partially exposed outside the base. The second electrodes are disposed in the base, electrically connected to the first electrodes, and each of the second electrodes is partially exposed outside the base. With the first electrodes and the second electrodes, the base is enabled to be electrically connected to another base for extension and expansion, and detachable illumination units are provided which can be freely arranged according to the user's requirement.

### BACKGROUND OF THE INVENTION

1. Field of the Invention

The present invention relates to a display signboard, and in particular to a signboard structure in which the display content is enabled to be freely changed through assembling bases and detachable illumination units.

2. Description of Related Art

In a signboard or display device composed of light sources such as light emitting diodes (LEDs), at least a LED is often installed on a circuit board, then a program is designed for controlling the illumination of each LED, such that the display content can be changed. As such, the content capable of being displayed has been set during the manufacturing of the signboard or display device, and the display content can only be selected from the settings stored in the products unless the program is altered for increasing the desired display content.

However, the occasion on which the signboard or display device being used has increased due to the social development. The content displayed on the signboard or display device has to be changed according to the applied occasion, or several different signboards or display devices have to be prepared for meeting the requirements of different occasions. Thus, the conventional art is not convenient and shall be improved.

### SUMMARY OF THE INVENTION

One primary objective of the present invention is to provide a signboard structure in which the display content is enabled to be freely changed through assembling.

For achieving said objective, the present invention provides a signboard structure, which includes a base, at least a pair of first electrodes and a pair of second electrodes. The base is formed with plural insertion holes, and includes a tenon and an engaging slot having a contour mated with the tenon. The first electrodes are disposed in the base corresponding to the locations of the insertion holes, and each of the first electrodes is partially exposed outside the base. The second electrodes are disposed in the base, electrically connected to the first electrodes, and each of the second electrodes is partially exposed outside the base.

Preferably, the signboard structure further includes at least an illumination unit detachably inserted in the insertion hole and electrically connected to the first electrodes.

Preferably, according to the signboard structure, the illumination unit includes an illumination part and an insertion part, and the insertion part is inserted in the insertion hole and electrically connected to a pair of the first electrodes.

Preferably, according to the signboard structure, the illumination part is a LED.

Preferably, according to the signboard structure, the tenon is engaged with an engaging slot formed on another base thereby connecting the bases.

Preferably, according to the signboard structure, the pair of second electrodes are electrically connected to another pair of second electrodes of another base.

Preferably, according to the signboard structure, the base includes a main body and a cover plate disposed on the main body, the insertion holes are formed on the cover plate, the first electrodes and the second electrodes are disposed in the main body, and the tenon and the engaging slot are formed on the cover plate.

Preferably, according to the signboard structure, the insertion holes are arranged in the base with an array format.

Preferably, according to the signboard structure, the base includes a main body and a cover plate disposed on the main body, the insertion holes are formed on the cover plate, and the first electrodes and the second electrodes are disposed in the main body.

With the assembled and extendable bases and the detachable illumination units, the illumination units can be freely arranged according to the user's requirement, so with respect to the requirement of different occasion, proper amount of bases and illumination units can be adopted and arranged to a desired display pattern/text, thereby effectively improving the disadvantage of not being able to change the display content with the respect to the user's requirement which exists in related art.

### BRIEF DESCRIPTION OF DRAWING

FIG. 1 is a perspective and exploded view showing a signboard structure according a preferred embodiment of the present invention;

FIG. 2 is a perspective and view showing the signboard structure according to a preferred embodiment of the present invention;

FIG. 3 is a cross sectional view of FIG. 2 taken alone line 3-3;

FIG. 4 is a side view showing the illumination unit of the present invention;

FIG. 5 is a schematic view showing the illumination unit of the present invention;

FIG. 6 is a cross sectional view of FIG. 2 taken alone line 6-6;

FIG. 7 is a schematic view illustrating the assembly state of the signboard structure of the present invention; and

FIG. 8 is a schematic view illustrating the operation state of the signboard structure of the present invention.

### DETAILED DESCRIPTION OF THE INVENTION

A preferred embodiment of the present invention will be described with reference to the drawings.

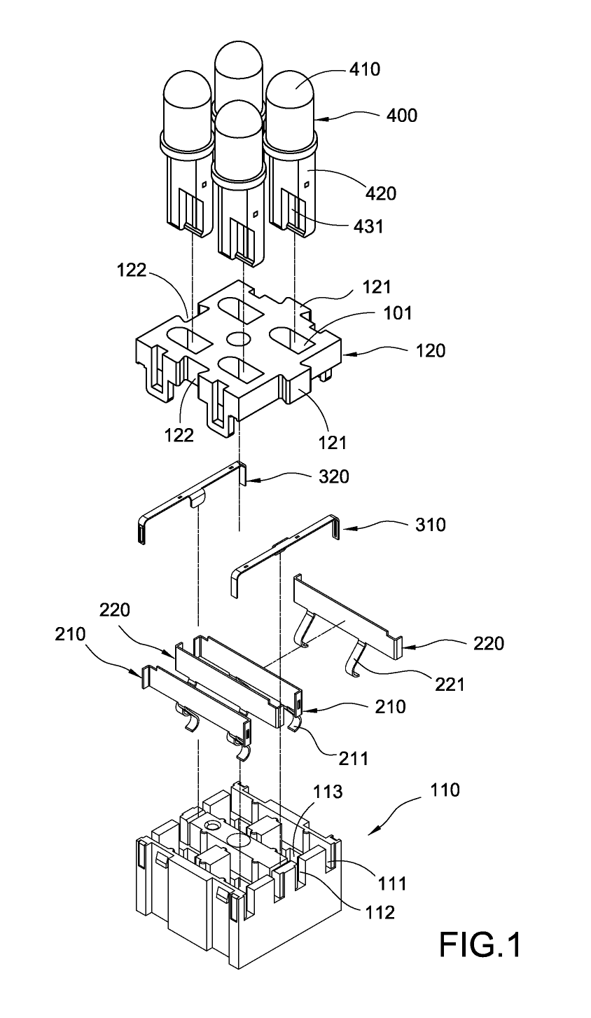

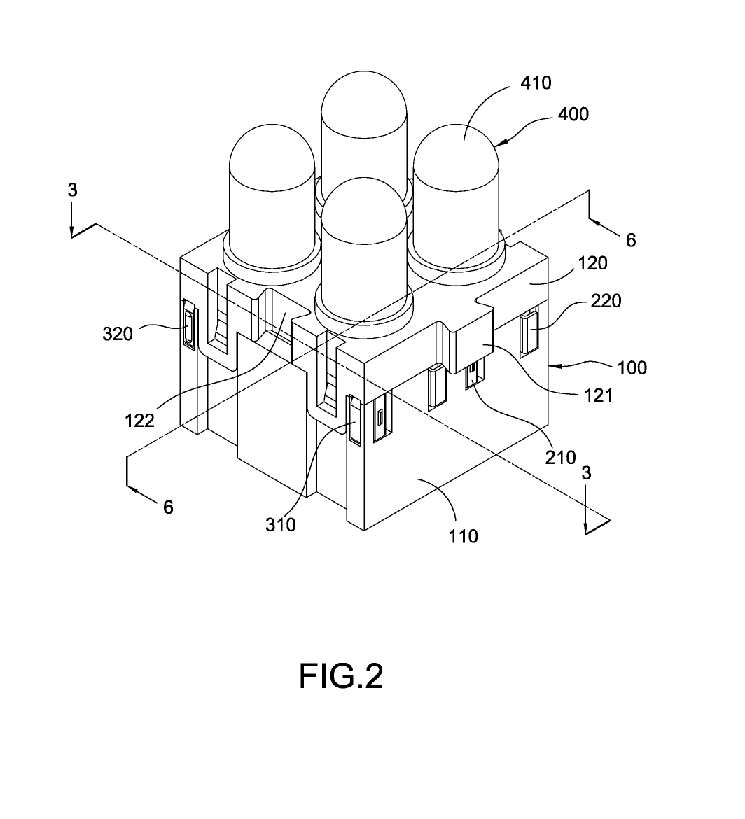

Please refer to FIG. 1 and FIG. 2, according to a preferred embodiment of the present invention, a signboard structure includes a base 100, two pairs of first electrodes 210, 220, one pair of second electrodes 310, 320 and at least an illumination unit 400.

The base 100 is substantially formed in a rectangular shape and made of an insulation material. The base 100 includes a main body 110 and a cover plate 120. The main body 110 is formed as a rectangular block member on which at least one pair of electrode slots 111, 112 are formed. At least an insertion slot 113 is formed between the two electrode slots 111, 112. According to this embodiment, the main body 110 is preferably formed with two pairs of electrode slots 111, 112 and four insertion slots 113, and two insertion slots 113 are disposed between each pair of electrode slots 111, 112. The cover plate 120 is disposed on the main body 110 for covering the electrode slots 111, 112 and the insertion slots 113. The cover plate 120 is formed as a rectangular plate member and penetratedly formed with plural insertion holes 101 at the locations corresponding to each of the insertion slots 113, and the insertion holes 101 are preferably arranged on the cover plate 120 with an array format. Preferably, opposite sides of the rectangular cover plate 120 are respectively formed with a tenon 121 and an engaging slot 122, the contour of the engaging slot 122 is mated with that of the tenon 121, and the tenon 121 is engaged with an engaging slot 122 formed on another base 100 thereby engaging and connecting with the two bases 100.

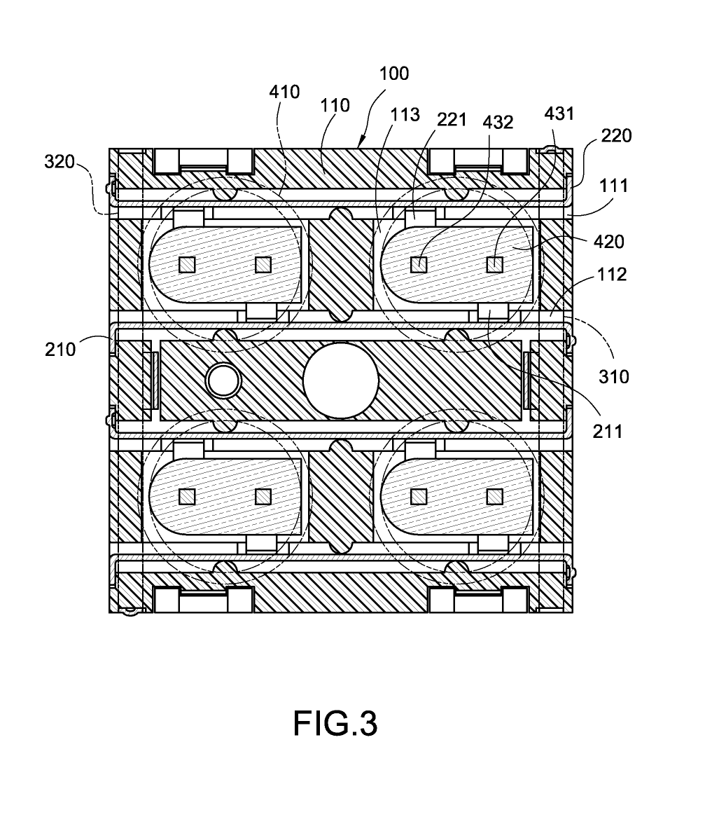

Please refer to FIG. 2 and FIG. 3, each of the first electrodes 210, 220 is an elongated metal sheet, and each pair of the first electrodes 210, 220 are respectively disposed in each of the electrode slots 111, 112, such that the two first electrodes 210, 220 of each pair of the first electrodes 210, 220 are oppositely arranged in the base 100 and corresponding to the locations of the insertion holes 101. In each of the insertion holes 101, the two first electrodes 210, 220 of each pair of the first electrodes 210, 220 are respectively extended with a resilient sheet 211, 221 from its edge and respectively formed at two sides of the insertion slot 113 corresponding to the insertion hole 101, and the two resilient sheets 211, 221 are staggeringly arranged. Two ends of each of the first electrodes 210, 220 are exposed outside the base 100 thereby being electrically connected to another corresponding first electrode 210, 220 of another base 100.

Each of the second electrodes 310, 320 is an elongated metal sheet. The second electrodes 310, 320 are perpendicular to the first electrodes 210, 220, disposed in the base 100 and electrically connected to each pair of the first electrodes 210, 220. Preferably, one of the first electrodes 210 of each pair of the first electrodes 210, 220 is electrically connected in parallel with one of the second electrodes 310 and the other first electrode 220 is electrically connected in parallel with the other second electrode 320. Two ends of each of the second electrodes 310, 320 are exposed outside the base 100 for being electrically connected to another pair of second electrodes 310, 320 of another base 100. When the mentioned base 100 is engaged and connected to another base 100, one of the second electrodes 310 of the base 100 is electrically connected to one of the second electrodes 310 of the another base 100, and the other second electrode 320 of the base 100 is electrically connected to the other second electrode 320 of the another base 100.

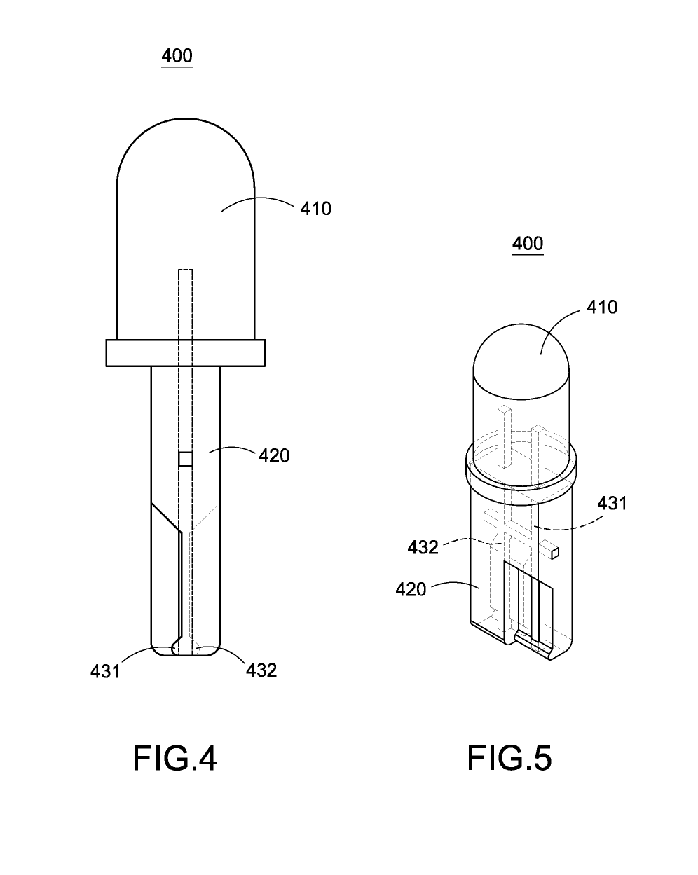

Please refer to FIG. 4 and FIG. 5, each of the illumination units 400 is detachably inserted in the insertion hole 101 and electrically connected to the first electrodes 210, 220, and each of the illumination unit 400 respectively includes an illumination part 410 and an insertion part 420. The illumination part 410 is preferably, but not limited, to be a light emitting diode (LED), for example the illumination part 410 can also be a light bulb. The interior of the insertion part 420 is installed with two third electrodes 431, 432 respectively and electrically connected to the illumination part 410. Each of the third electrodes 431, 432 is respectively exposed at two opposite sides of the insertion part 420 and the electrodes 431, 432 are staggeringly arranged.

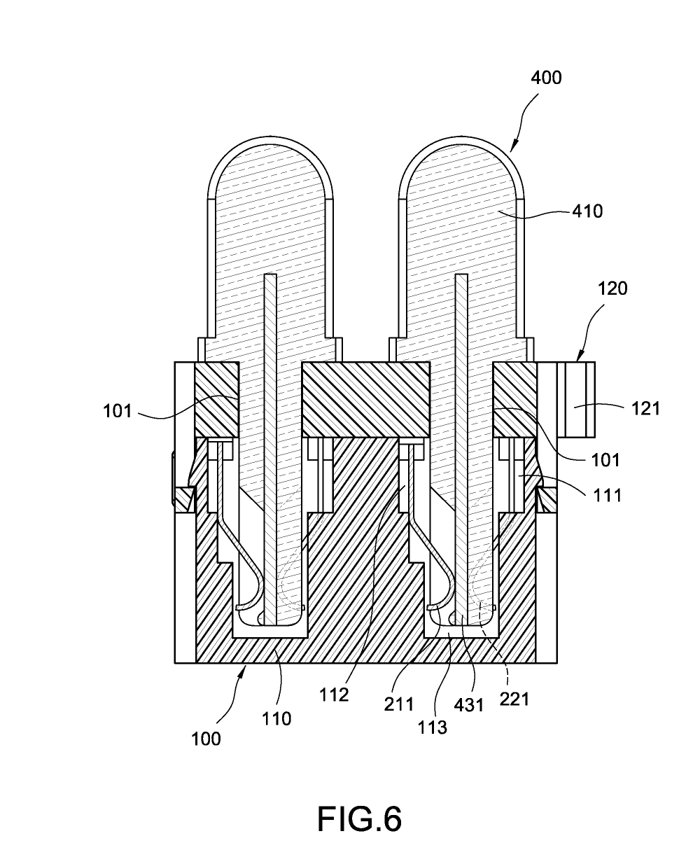

Please refer from FIG. 3 to FIG. 6, the insertion part 420 can be inserted in any of the insertion holes 101 thereby being received in the insertion slot 113 corresponding to the insertion hole 101 and clamped between the two resilient sheets 211, 221 corresponding to the insertion slot 113, so the two third electrodes 431, 432 are enabled to be respectively in contact with the two resilient sheets 211, 221, and the two third electrodes 431, 432 are allowed to be electrically connected to the two first electrodes 210, 220 corresponding to the insertion hole 101.

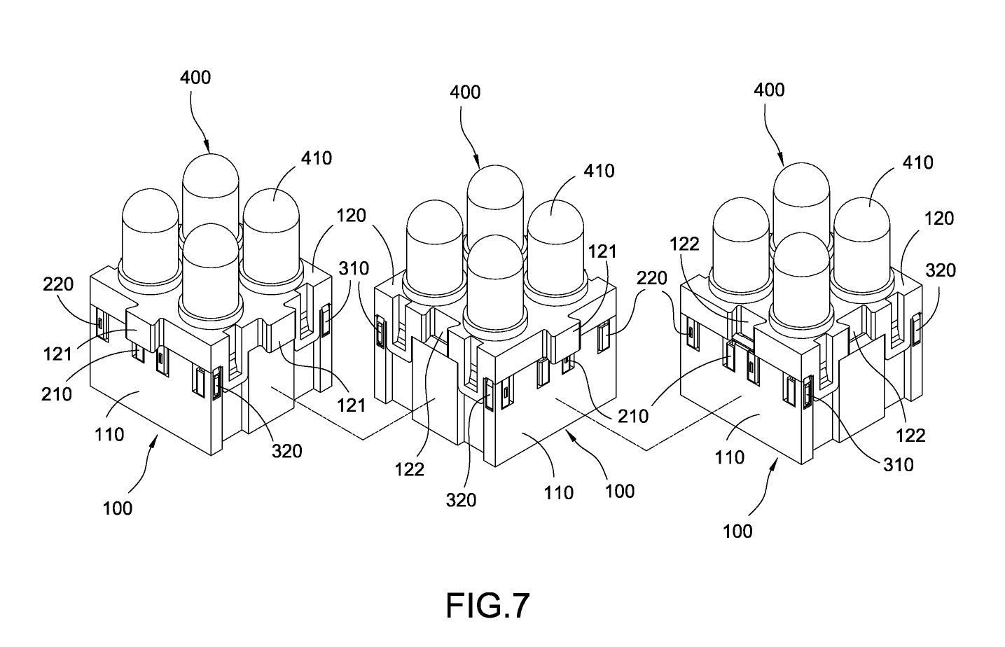

Please refer to FIG. 7, according to the signboard structure provided by the present invention, the base 100 is enabled to be engaged and connected to another base 100, so with respect to the dimension requirement, different amount of the bases 100 can be adopted for assembling the desired signboard. With the first electrodes 210, 220 and the second electrodes 310, 320, the illumination units 400 are enabled to be electrically connected with each other on the base 100 in different connecting directions.

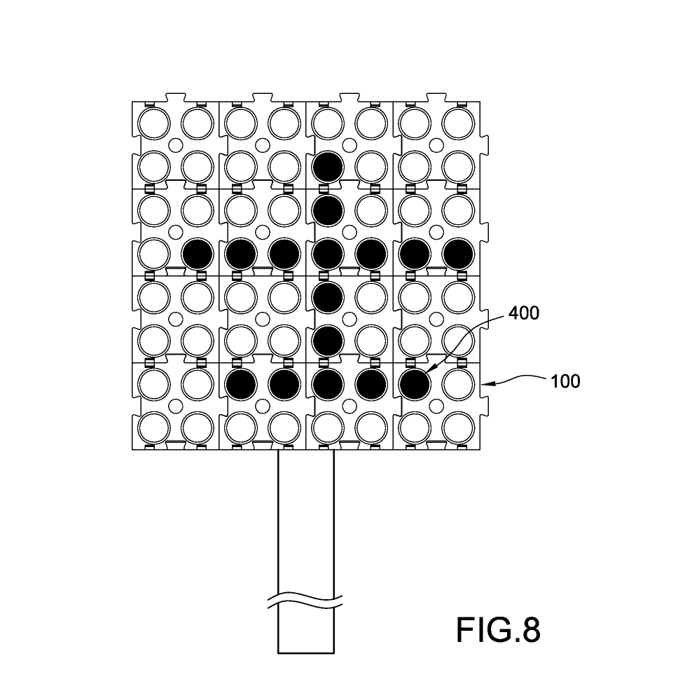

Please refer to FIG. 8, the plural illumination units 400 are inserted in the insertion holes 101 of the base 100 according to the user's requirement for displaying a desired content, and electricity is supplied to the second electrodes 310, 320 for enabling the illumination units 400 to emit light, so different display content can be provided with respect to the applied occasions. The amount of the base 100 and the amount of the illumination unit 400 are determined according to the actual needs, so the installation of unnecessary insertion holes 101 and illumination units 400 can be saved, thereby improving the disadvantage of not being able to change the display content with the respect to the user's requirement which exists in related art.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A signboard structure including:
a base, formed with plural insertion holes, and including a tenon and an engaging slot having a contour mated with said tenon;
at least a pair of first electrodes, disposed in said base corresponding to the locations of said insertion holes, and each of said first electrodes being partially exposed outside said base; and
a pair of second electrodes, disposed in said base, electrically connected to said first electrodes, and each of said second electrodes being partially exposed outside said base.

2. The signboard structure according to claim 1, further including at least an illumination unit detachably inserted in said insertion hole and electrically connected to said first electrodes.

3. The signboard structure according to claim 2, wherein said illumination unit includes a light emitting diode.

4. The signboard structure according to claim 2, wherein said illumination unit includes an illumination part and an insertion part, and said insertion part is inserted in said insertion hole and electrically connected to a pair of said first electrodes.

5. The signboard structure according to claim 4, wherein said illumination part is a light emitting diode.

6. The signboard structure according to claim 1, wherein said tenon is engaged with an engaging slot formed on another base, thereby connecting said bases.

7. The signboard structure according to claim 1, wherein said pair of second electrodes are electrically connected to another pair of second electrodes of another base.

8. The signboard structure according to claim 1, wherein said base includes a main body and a cover plate disposed on said main body, said insertion holes are formed on said cover plate, said first electrodes and said second electrodes are disposed in said main body, and said tenon and said engaging slot are formed on said cover plate.

9. The signboard structure according to claim 1, wherein said insertion holes are arranged in said base with an array format.

10. The signboard structure according to claim 1, wherein said base includes a main body and a cover plate disposed on said main body, said insertion holes are formed on said cover plate, and said first electrodes and said second electrodes are disposed in said main body.
